(19) United States
(12) Patent Application Publication
(10) Pub. No.: US 2016/0236329 A1
(43) Pub. Date: Aug. 18, 2016

(54) SPRING-LOADED UNIVERSAL TRANSMITTER ENCLOSURE ASSISTED OPERATION TOOL

(71) Applicant: Honeywell International Inc., Morristown, NJ (US)

(72) Inventors: Michael Petro, Palatine, IL (US); Randy Michael Billingsley, Chicago, IL (US); Bassam Yousef, Des Plaines, IL (US)

(21) Appl. No.: 14/620,383

(22) Filed: Feb. 12, 2015

(51) Int. Cl. B25B 13/50; B25B 23/00; B25B 15/00

(52) U.S. Cl. CPC B25B 13/50; B25B 15/004; B25B 23/0035

(57) ABSTRACT

A transmitter housing cap removal apparatus and method. The transmitter housing cap removal apparatus can be configured to include a spool portion having a ball bearing mount and spring, and a device housing having a wrench assisting hex nut component and a gripping surface, wherein the device housing engages with the spool portion. The transmitter housing cap removal apparatus further includes a spring mounting plate attached to an interior portion of the device housing, and a spring-loaded multiblock mating surface assembly, wherein the spring mounting plate is located within the device housing to provide a surface for the spring-loaded multiblock mating surface assembly to be mounted thereto. The transmitter housing cap removal apparatus can incorporate a multiblock stopping plate that engages with and prevents movement of the spring-loaded multiblock mating surface to assist in permitting removal of the transmitter housing cap.

### TECHNICAL FIELD

Embodiments are related to transmitter enclosures and housing devices. Embodiments further relate to transmitter housing caps and transmitters utilized in sensor applications.

### BACKGROUND

A variety of transmitter housing styles have been implemented which generally employ a screw style cap to protect internal components. These caps are intended to be hand-tightened; however, they can be over tightened to the point that they require some form of mechanical advantage to open. Typically, this involves using a tool with a long flat portion (e.g., screwdriver, wrench handle, etc.) to attempt to generate the necessary force to loosen the cap. Such tools are placed as best as possible into the pattern of the cap as the user attempts to turns them and generate the torque.

Because many of the caps have a low profile pattern, the tools will slip out of place with the force applied which can injure the user and damage the transmitter housing. There is currently not a procedure or tool available for removing a stuck transmitter housing cap in a safe manner. This can be especially true for transmitters in the field, which may have been subject to environmental exposure that introduced debris into the threading.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved transmitter housing cap removal apparatus.

The aforementioned aspects and other objectives and advantages can now be achieved as described herein. A transmitter housing cap removal apparatus and method of configuring the apparatus are disclosed. In a preferred embodiment, the transmitter housing cap removal apparatus can be configured to include a spool portion having a ball bearing mount and spring, and a device housing having a wrench assisting hex nut component and a gripping surface, wherein the device housing engages with the spool portion. The transmitter housing cap removal apparatus further includes a spring mounting plate attached to an interior portion of the device housing, and a spring-loaded multiblock mating surface assembly, wherein the spring mounting plate is located within the device housing to provide a surface for the spring-loaded multiblock mating surface assembly to be mounted thereto. Finally, the transmitter housing cap removal apparatus can incorporate a multiblock stopping plate that engages with and prevents movement of the spring-loaded multiblock mating surface to assist in permitting removal of the transmitter housing cap.

The spool portion further includes a spool piece comprising a cylinder having two flat pieces on each end of the cylinder. Additionally, a ball bearing ring having the cylinder inserted therethrough can be provided. The spool portion can further include a free rotating handle that allows for application of force while allowing the housing device to rotate.

The device housing can be further configured to include an integrated assembly having a hollow puck-shaped cylindrical tube with an end face, wherein the end face includes a hex nut shaped protrusion that allows for engagement with and use by a wrench. The hex nut shaped protrusion assists in mounting of the spool portion. In some embodiments, a gripping material can be located on and external to the device housing in association with a group of inlays configured on the device housing to allow for ergonomic holding and turning.

In another embodiment, the spring-loaded multiblock mating surface assembly can further include blocks that provide a universal pattern matching surface, wherein such blocks can respectively include a group of springs that force the block to remain extended. In yet another embodiment, the multiblock stopping plate can be configured to prevent the blocks from extending beyond an optimal range while also protecting the spring and the ball bearing mount. The multiblock stopping plate serves to close the spring-loaded multiblock mating surface assembly.

In still another embodiment, the springs can respectively force surface matching pegs (or pins) downward and the pegs/pins can compress to match a pattern on a transmitter housing cap.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates different configurations, which may be implemented for a transmitter housing cap, in accordance with varying embodiments;

FIG. 2 illustrates a schematic diagram of a transmitter housing cap removal apparatus, in accordance with a preferred embodiment;

FIG. 3 illustrates a schematic diagram of a transmitter housing cap removal apparatus, in accordance with an alternative embodiment; and

FIG. 4 illustrates a top view of a transmitter housing cap removal apparatus, in accordance with an alternative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown.

The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout. As used herein, the term “and/or” includes any and all combinations of one or more of the associated listed items.

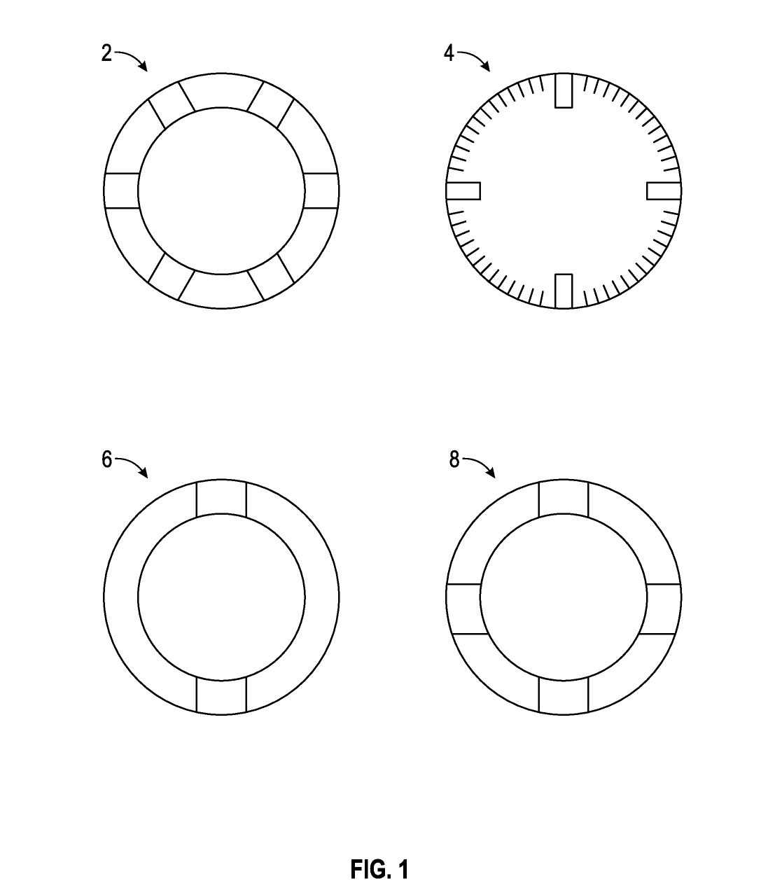

FIG. 1 illustrates different configurations and designs, which may be implemented for a transmitter housing cap, in accordance with varying embodiments. The transmitter enclosure assisted opening tool, which is discussed in greater detail herein, can be utilized to open the various transmitter housing caps 2, 4, 6, and 8 shown in FIG. 1.

The disclosed embodiments offer a solution to the problems identified previously. Such a solution must allow force to hold the device to the transmitter cap (e.g., such as the caps 2, 4, 6, 8) shown in FIG. 1, and must provide a method of transferring the torque from the user to the cap. Additionally, such a solution should offer a feature that allows it to adjust to a variety of transmitter housing cap styles such as those shown, for example, in FIG. 1.

As will be discussed in greater detail shortly, in order to transfer the force to hold the device into place, the device has a spool piece mounted via a ball bearing. This creates a flat surface for the force to be applied to while the ball bearing system allows for the free rotation of the device, minimizing the rotational stress placed back on the user. The torque generated by the user can be transferred through the device in two separates methods: the gripping surface of the housing or the wrench-assisting hex nut. A gripping surface of the housing creates a larger, more ergonomic surface for the user to hold on to in order to generate a larger, more stable force towards opening the cap. If needed, the user can utilize a wrench on the wrench-assisting hex nut in order to generate the necessary force to loosen the cap.

One of the novel and important features of the disclosed device addresses the accommodation of multiple cap designs. A spring-loaded multiblock mating surface system can be implemented to adjust to the cap design to ensure that forces are optimally applied to the cap surface. This surface includes a series of blocks that give way to the raised surface features of the cap, creating a near mirror image surface of the cap. This configuration allows the torque forces to be applied to the surface features of the cap in the optimal locations. Additionally, each block can be tipped with a gripping material to ensure that no force is wasted.

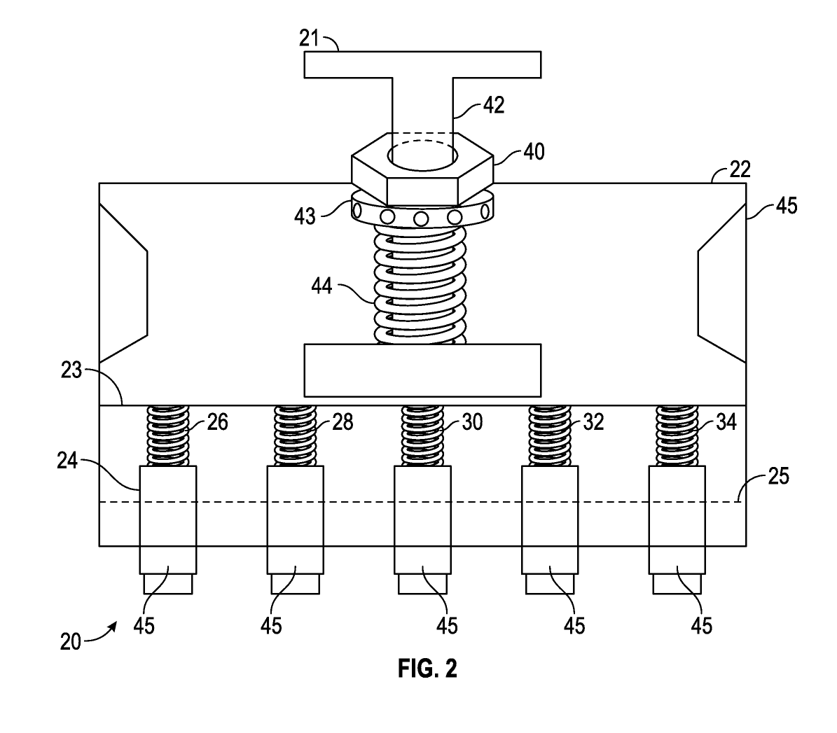

FIG. 2 illustrates a schematic diagram of a transmitter housing cap removal apparatus 20, in accordance with a preferred embodiment. The transmitter housing cap removal apparatus 20 can be configured to include a spool portion 21 having a ball bearing mount 43 and spring(s) 44, and a device housing 22 having a wrench assisting hex nut 40 component and a gripping surface 45, wherein the device housing 22 engages with the spool portion 21. The transmitter housing cap removal apparatus 20 further includes a spring mounting plate 23 attached to an interior portion of the device housing 22 and a spring-loaded multiblock mating surface assembly 24. The spring mounting plate 23 is located within the device housing 22 to provide a surface for the spring-loaded multiblock mating surface assembly 24 to be mounted thereto. The transmitter housing cap removal apparatus 20 can incorporate a multiblock stopping plate 25 that engages with and prevents movement of the spring-loaded multiblock mating surface assembly 24 to assist in permitting removal of a transmitter housing cap such as, for example, the caps 2, 4, 6, etc. depicted in FIG. 1.

The spool portion 21 is provided as a spool piece that includes a cylinder having two flat pieces on each end of the cylinder. Additionally, a ball bearing ring having the cylinder inserted therethrough can be provided. The spool portion 21 can further include a free rotating handle 42 that allows for application of force while allowing the housing device to rotate.

The device housing 22 can be further configured to include an integrated assembly having a hollow puck-shaped cylindrical tube with an end face, wherein the end face includes a hex nut shaped protrusion that allows for engagement with and use by a wrench, the hex nut shaped protrusion assists in mounting of the spool portion. In some embodiments, a gripping material can be located on and external to the device housing 22 in association with a group of inlays configured on the device housing to allow for ergonomic holding and turning.

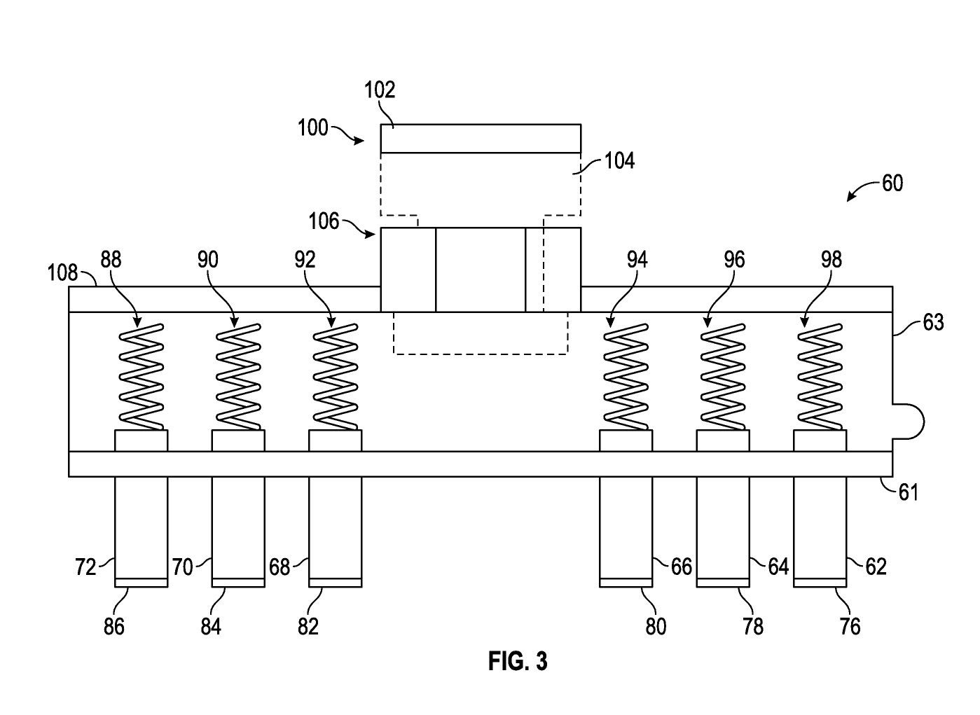

In another embodiment, the spring-loaded multiblock mating surface assembly 24 can further include blocks that provide a universal pattern matching surface, wherein such blocks can respectively include a group of springs 26, 28, 30, 32, and 34 that force the block to remain extended. In yet another embodiment, the multiblock stopping plate 25 can be configured to prevent the blocks from extending beyond an optimal range while also protecting the spring and the ball bearing mount. The multiblock stopping plate 25 serves to close the spring-loaded multiblock mating surface assembly 24. The springs 26, 28, 30, 32, and 34 can respectively force surface matching pegs or pins 45 downward and the pegs 45 can compress to match a pattern on the transmitter housing cap. Examples of such pegs/pins are shown in greater detail in FIG. 3.

FIG. 3 illustrates a schematic diagram of a transmitter housing cap removal apparatus 60, in accordance with an alternative embodiment. Note that the configuration shown in FIG. 3 is similar to the arrangement depicted in FIG. 2 albeit with variations. The transmitter housing cap removal apparatus 60 includes pins 62, 64, 66, 68, 70, and 72 which are under constant pressure to remain out until a force is applied to the surface. That is, the surfaces of pins 62, 64, 66, 68, 70, and 72 are respectively coated with a grippable material 76, 78, 80, 82, 84, and 86 to ensure slip resistance. A pin holding plate 61 prevents the pins 62, 64, 66, 68, 70, and 72 from coming out of the device housing 63. A group of springs 88, 90, 92, 94, 96, and 98 respectively contact pins 72, 70, 68, 66, 64, and 62 within the device housing 63. A surface mounted grippable surface 108 allows for operation without the assistance of additional tools. A hex head 100 can provide for the use of standard tools, if necessary. A surface 102 is coated with a grippable material to also ensure slip resistance. A spool portion 104 allows for an even force to be applied to the surface 102.

The devices 20 and 60 respectively depicted in FIGS. 2-3 are generally composed of five components: 1) a spool piece/portion with a ball bearing mount; 2) a device housing with a wrench assisting hex nut component and gripping surface; 3) a spring mounting plate; 4) a spring-loaded multiblock mating surface assembly; and 5) a multiblock stopping plate.

The a spool piece/portion is composed of a spool piece and a cylinder with two flat pieces on each end, which has a ball bearing ring around the center. The ball bearing ring mounts to the device housing, allowing the spool piece to be fixed to the housing, but remains free spinning. The device housing is preferably configured as one solid piece. As indicated previously, the device housing can be provided as a hollow puck shaped cylinder that only has one end face. On the face, a hex nut shaped protrusion can be provided which allows for the use of a wrench. A hole can be drilled through the protrusion for the mounting of the spool piece/portion. Around the outside of the device housing is a gripping material and a series of inlays that allow for ergonomic holding and turning. The overall housing diameter is large enough to accommodate the largest of major manufactures' standard transmitter housing caps. Attached to the inside of the device housing is a spring mounting plate, which provides a surface for the spring-loaded multiblock mating surface assembly to be mounted thereto.

The spring-loaded multiblock mating surface system or assembly includes a series of strategically arranged blocks to create a “universal” pattern matching surface. Each of these block has a spring that forces the block to remain extended. To prevent the blocks from extending too far and to protect the internal springs and ball bearing mounting is the multiblock stopping plate, which closes the spring-loaded multiblock mating surface assembly.

To utilize the device, the user simply places the spring-loaded multiblock mating surface on to the transmitter housing cap and applies a force towards the transmitter using the flat surface of the spool piece. This pressure causes the mating surface to compress blocks that coordinate to raised surfaces on the cap. At this point, the user can use the ergonomic gripping surface on the housing to turn the device, loosening the transmitter cap, or if needed, can use a wrench on the proper device surface. Once the cap is loose enough, it can be removed by hand or the tool can be used until the cap is completely free of the transmitter housing.

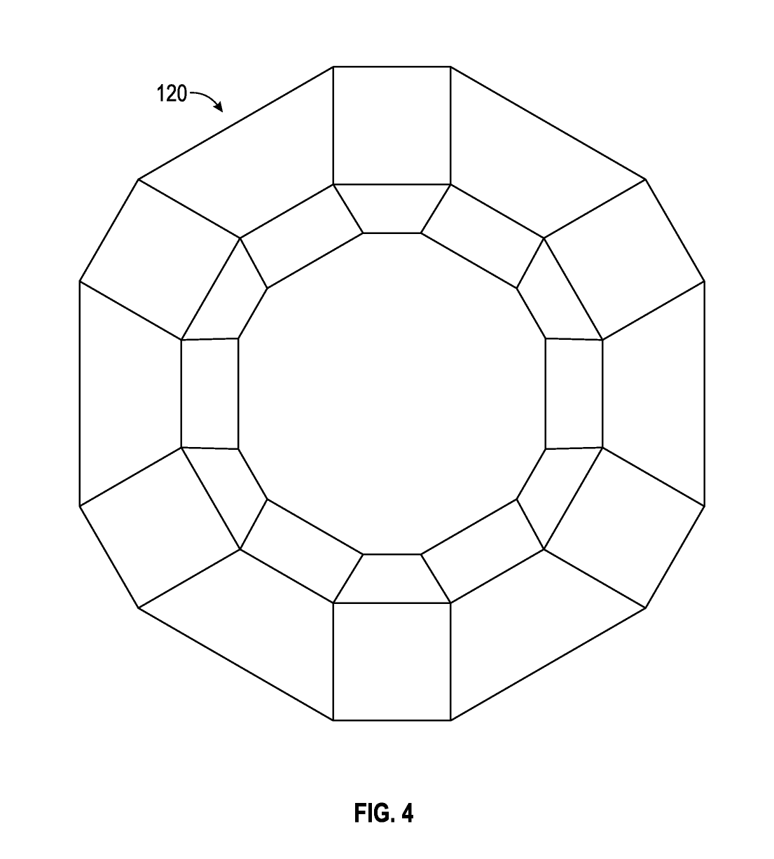

FIG. 4 illustrates a top view of a transmitter housing cap removal apparatus 120, in accordance with an alternative embodiment. It can be appreciated that the configuration shown in FIG. 4 represents merely one possible embodiment and that variations to the top view design shown in FIG. 4 are likely.

Based on the foregoing, it can be appreciated that a number of embodiments, preferred and alternative, are disclosed herein. For example, in a preferred embodiment, a transmitter housing cap removal apparatus can be configured, which includes a spool portion having a ball bearing mount and spring; a device housing having a wrench assisting hex nut component and a gripping surface, wherein the device housing engages with the spool portion; a spring mounting plate attached to an interior portion of the device housing; a spring-loaded multiblock mating surface assembly, wherein the spring mounting plate is located within the device housing to provide a surface for the spring-loaded multiblock mating surface assembly to be mounted thereto; and a multiblock stopping plate that engages with and prevents movement of the spring-loaded multiblock mating surface to assist in permitting removal of the transmitter housing cap.

In some embodiments, the spool portion can further include a spool piece comprising a cylinder having two flat pieces on each end of the cylinder. In yet other embodiments, the disclosed apparatus may include a ball bearing ring having the cylinder inserted therethrough. In still other embodiments, the spool portion can further include a free rotating handle that allows for the application of force while allowing the housing device to rotate.

In another embodiment, the device housing can further include an integrated assembly having a hollow puck-shaped cylindrical tube with an end face, wherein the end face includes a hex nut shaped protrusion that allows for engagement with and use by a wrench. The hex nut shaped protrusion assists in mounting of the spool portion. In yet another embodiment, a gripping material can be located on and external to the device housing in association with a group of inlays configured on the device housing to allow for ergonomic holding and turning.

In another embodiment, the spring-loaded multiblock mating surface assembly can further include one or more blocks that provide a universal pattern matching surface, wherein the blocks include respectively springs that forces the block(s) to remain extended. In still another embodiment, the multiblock stopping plate can be configured to prevent the blocks from extending beyond an optimal range and protects the spring and the ball bearing mount, wherein the multiblock stopping plate closes the spring-loaded multiblock mating surface assembly. In yet another embodiment, the springs respectively force surface matching pegs downward and wherein the pegs compress to match a pattern on a transmitter housing cap.

In another embodiment, a transmitter housing cap removal apparatus can be provided, which includes, for example: a spool portion having a ball bearing mount and spring, the spool portion comprising a spool piece comprising a cylinder having two flat pieces on each end of the cylinder, wherein a ball bearing ring includes the cylinder inserted therethrough; a device housing having a wrench assisting hex nut component and a gripping surface, wherein the device housing engages with the spool portion; a spring mounting plate attached to an interior portion of the device housing; a spring-loaded multiblock mating surface assembly, wherein the spring mounting plate is located within the device housing to provide a surface for the spring-loaded multiblock mating surface assembly to be mounted thereto; and a multiblock stopping plate that engages with and prevents movement of the spring-loaded multiblock mating surface to assist in permitting removal of the transmitter housing cap, the spool portion further comprising a free rotating handle that allows for application of force while allowing the housing device to rotate.

In another embodiment, a method of configuring a transmitter housing cap removal apparatus can be implemented. Such a method can include the steps of, for example, providing a spool portion having a ball bearing mount and spring; configuring a device housing to include a wrench assisting hex nut component and a gripping surface, wherein the device housing engages with the spool portion; attaching a spring mounting plate to an interior portion of the device housing; locating a spring-loaded multiblock mating surface assembly within the device housing to provide a surface for the spring-loaded multiblock mating surface assembly to be mounted thereto; and providing a multiblock stopping plate that engages with and prevents movement of the spring-loaded multiblock mating surface to assist in permitting removal of the transmitter housing cap.

In another embodiment, a step can be implemented for modifying the spool portion to further include a spool piece comprising a cylinder having two flat pieces on each end of the cylinder. In still another embodiment, steps can be implemented for providing a ball bearing ring having the cylinder inserted therethrough; and configuring the spool portion to further comprises a free rotating handle that allows for application of force while allowing the housing device to rotate.

In another embodiment, a step can be implemented for configuring the device housing to further include an integrated assembly having a hollow puck-shaped cylindrical tube with an end face. The end face can include a hex nut shaped protrusion that allows for engagement with and use by a wrench, which assists in mounting of the spool portion.

In yet another embodiment, steps can be provided for configuring the spring-loaded multiblock mating surface assembly to further include one or more blocks that provide a universal pattern matching surface, wherein the blocks include respectively a plurality of springs that forces the block to remain extended; modifying the multiblock stopping plate to prevent the blocks from extending beyond an optimal range and protects the spring and the ball bearing mount, wherein the multiblock stopping plate closes the spring-loaded multiblock mating surface assembly; and configuring the springs to respectively force surface matching pegs downward, wherein the pegs compress to match a pattern on a transmitter housing cap.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure and all such modifications are intended to be included within the scope of the disclosure.

1. A transmitter housing cap removal apparatus, comprising:
a spool portion having a ball bearing mount and spring;
a device housing having a wrench assisting hex nut component and a gripping surface, wherein said device housing engages with said spool portion;
a spring mounting plate attached to an interior portion of said device housing;
a spring-loaded multiblock mating surface assembly, wherein said spring mounting plate is located within said device housing to provide a surface for said spring-loaded multiblock mating surface assembly to be mounted thereto; and
a multiblock stopping plate that engages with and prevents movement of said spring-loaded multiblock mating surface to assist in permitting removal of said transmitter housing cap.

2. The apparatus of claim 1 wherein said spool portion further comprises a spool piece comprising a cylinder having two flat pieces on each end of said cylinder.

3. The apparatus of claim 2 further comprising a ball bearing ring having said cylinder inserted therethrough.

4. The apparatus of claim 2 wherein said spool portion further comprises a free rotating handle that allows for application of force while allowing said housing device to rotate.

5. The apparatus of claim 1 wherein said device housing further comprises an integrated assembly having a hollow puck-shaped cylindrical tube with an end face, wherein said end face includes a hex nut shaped protrusion that allows for engagement with and use by a wrench, said hex nut shaped protrusion having therein for mounting of said spool portion.

6. The apparatus of claim 5 further comprising a gripping material located on and external to said device housing in association with a plurality of inlays configured on said device housing to allow for ergonomic holding and turning.

7. The apparatus of claim 1 wherein said spring-loaded multiblock mating surface assembly further comprises a plurality of blocks that provide a universal pattern matching surface, wherein said plurality of blocks include respectively a plurality of springs that forces said block to remain extended.

8. The apparatus of claim 7 wherein said multiblock stopping plate prevents said plurality of blocks from extending beyond an optimal range and protects said spring and said ball bearing mount, wherein said multiblock stopping plate closes said spring-loaded multiblock mating surface assembly.

9. The apparatus of claim 7 wherein said plurality of springs respectively forces a plurality of surface matching pegs downward, wherein said plurality of pegs compress to match a pattern on a transmitter housing cap.

10. A transmitter housing cap removal apparatus, comprising:
a spool portion having a ball bearing mount and spring, said spool portion comprising a spool piece comprising a cylinder having two flat pieces on each end of said cylinder, wherein a ball bearing ring includes said cylinder inserted therethrough;
a device housing having a wrench assisting hex nut component and a gripping surface, wherein said device housing engages with said spool portion;
a spring mounting plate attached to an interior portion of said device housing;
a spring-loaded multiblock mating surface assembly, wherein said spring mounting plate is located within said device housing to provide a surface for said spring-loaded multiblock mating surface assembly to be mounted thereto; and
a multiblock stopping plate that engages with and prevents movement of said spring-loaded multiblock mating surface to assist in permitting removal of said transmitter housing cap, said spool portion further comprising a free rotating handle that allows for application of force while allowing said housing device to rotate.

11. The apparatus of claim 10 wherein said device housing further comprises an integrated assembly having a hollow puck-shaped cylindrical tube with an end face, wherein said end face includes a hex nut shaped protrusion that allows for engagement with and use by a wrench, said hex nut shaped protrusion having therein for mounting of said spool portion.

12. The apparatus of claim 11 further comprising a gripping material located on and external to said device housing in association with a plurality of inlays configured on said device housing to allow for ergonomic holding and turning.

13. The apparatus of claim 10 wherein said spring-loaded multiblock mating surface assembly further comprises a plurality of blocks that provide a universal pattern matching surface, wherein said plurality of blocks include respectively a plurality of springs that forces said block to remain extended.

14. The apparatus of claim 13 wherein said multiblock stopping plate prevents said plurality of blocks from extending beyond an optimal range and protects said spring and said ball bearing mount, wherein said multiblock stopping plate closes said spring-loaded multiblock mating surface assembly.

15. The apparatus of claim 13 wherein said plurality of springs respectively forces a plurality of surface matching pegs downward, wherein said plurality of pegs compress to match a pattern on a transmitter housing cap.

16. A method of configuring a transmitter housing cap removal apparatus, said method comprising:
providing a spool portion having a ball bearing mount and spring;
configuring a device housing to include a wrench assisting hex nut component and a gripping surface, wherein said device housing engages with said spool portion;
attaching a spring mounting plate to an interior portion of said device housing;
locating a spring-loaded multiblock mating surface assembly within said device housing to provide a surface for said spring-loaded multiblock mating surface assembly to be mounted thereto; and
providing a multiblock stopping plate that engages with and prevents movement of said spring-loaded multiblock mating surface to assist in permitting removal of said transmitter housing cap.

17. The method of claim 16 further comprising:
modifying said spool portion to further include a spool piece comprising a cylinder having two flat pieces on each end of said cylinder

18. The method of claim 17 further comprising:
providing a ball bearing ring having said cylinder inserted therethrough; and
configuring said spool portion to further comprises a free rotating handle that allows for application of force while allowing said housing device to rotate.

19. The method of claim 16 wherein said device housing further comprises an integrated assembly having a hollow puck-shaped cylindrical tube with an end face, wherein said end face includes a hex nut shaped protrusion that allows for engagement with and use by a wrench, said hex nut shaped protrusion having therein for mounting of said spool portion.

20. The method of claim 16 further comprising:
configuring said spring-loaded multiblock mating surface assembly to further include a plurality of blocks that provide a universal pattern matching surface, wherein said plurality of blocks include respectively a plurality of springs that forces said block to remain extended;
modifying said multiblock stopping plate to prevent said plurality of blocks from extending beyond an optimal range and protects said spring and said ball bearing mount, wherein said multiblock stopping plate closes said spring-loaded multiblock mating surface assembly; and
configuring said plurality of springs to respectively force a plurality of surface matching pegs downward, wherein said plurality of pegs compress to match a pattern on a transmitter housing cap.
